(19) United States
(12) Patent Application Publication
(10) Pub. No.: US 2005/0195548 A1
(43) Pub. Date: Sep. 8, 2005

(54) Low-voltage power circuit breaker having an electronic overcurrent release and an operating-state detection device

(76) Inventors: Andreas Pancke, Berlin (DE); Wolfgang Roehl, Berlin (DE); Manfred Schiller, Berlin (DE)

Correspondence Address: HARNESS, DICKEY & PIERCE, P.L.C., P.O.BOX 8910, RESTON, VA, 20195, US

(21) Appl. No.: 11/070,241

(22) Filed: Mar. 3, 2005

(30) Foreign Application Priority Data
Mar. 4, 2004 (DE) 10 2004 011 025.5

(51) Int. Cl. H02H 3/00

(52) U.S. Cl. 361/115

(57) ABSTRACT

A low-voltage power circuit breaker includes an electronic overcurrent release, which draws its operating energy from the power supply system monitored by the low-voltage power circuit breaker, and an operating-state detection device. Since it is possible for the power circuit breaker to switch to a short circuit on connection, it may be appropriate for no undelayed tripping of the power circuit breaker to be permitted directly after connection, or for the tripping time for the delayed tripping to be altered. Provision is made for the operating-state detection device to be a device for detecting a connection operation, whose output signal is fed to the overcurrent release, which sets a different disconnection time for the low-voltage power circuit breaker at the beginning of a connection operation for a predetermined period of time.

The present application hereby claims priority under 35 U.S.C. §119 on German patent application numbers DE 10 2004 011 025.5 filed Mar. 4, 2004, the entire contents of which is hereby incorporated herein by reference.

### FIELD OF THE INVENTION

The invention generally relates to a low-voltage power circuit breaker. Preferably, it relates to one having an electronic overcurrent release, which draws its operating energy from the power supply system monitored by the low-voltage power circuit breaker, and an operating-state detection device.

### BACKGROUND OF THE INVENTION

Electronic overcurrent releases serve the purpose of monitoring the current in a single- or polyphase power supply system for the occurrence of overcurrents and short-circuit currents. Depending on the level of an impermissibly high current measured by current transformers, the overcurrent release causes delayed or undelayed tripping of the low-voltage power circuit breaker.

Since it is possible for the power circuit breaker to switch to a short circuit on connection, it may be appropriate for no undelayed tripping of the power circuit breaker to be permitted directly after connection, or for the tripping time for the delayed tripping to be altered. This is because, in such a case, the current already flows in an arc shortly before the main current contacts come into contact with one another and the switching operation is concluded. In addition, the spring drive also has a certain overtravel, once the main current contacts have come into contact.

Reverse control by way of a reversal of the switching direction would mean, at such a time, an impermissibly high load on the mechanical parts of the power breaker. For this purpose, the electronic release must detect the present switching state of the power circuit breaker, since, in the no-current state, it is not capable of storing the disconnection operation which has previously taken place, i.e. it does not recognize its present operating state.

Low-voltage power circuit breakers are already known with which the present operating state of the power circuit breaker is detected for other reasons and is displayed for the benefit of the operator of the electrical system. For example, DE 100 44 058 C1 discloses an electrical switch having an electronic release block, in which the position, which depends on the switching position of the normally open contacts of the switch, of a locking rod causes mechanical locking of the release block such that it cannot be removed from the switch when the switch is in the closed position. At the same time, the position of the locking rod is displayed visually using a window in the front wall of the switch.

EP 0 905 846 A2 also discloses an electronic overcurrent tripping device which is equipped with a data display on which the connection state and, in the event of an overcurrent, the remaining time until the switch is tripped are displayed. The operator of the system can thus take suitable measures in the event of delayed tripping as a result of an overload. If it is also intended for the disconnection state, for example as a result of a short circuit, to be displayed, the overcurrent release needs, however, to be equipped with a dedicated energy supplier, since, in the disconnected state of the power circuit breaker, no energy is subsequently supplied from the power supply system.

### SUMMARY OF THE INVENTION

An embodiment of the invention is based on an object of specifying a low-voltage power circuit breaker, in which a connection is detected in order to be able to influence the tripping time over a short period of time.

Accordingly, the operating-state detection device is a device for detecting a connection operation, whose output signal is fed to the overcurrent release, which sets a different disconnection time for the low-voltage power circuit breaker at the beginning of a connection operation for a predetermined period of time.

For example, a minimum tripping time can be set for a period of time of approximately 100 ms.

One preferred refinement of an embodiment of the invention provides for the device for detecting a connection operation to be a momentary contact switch, which is mechanically connected to the main current contacts of the low-voltage power circuit breaker, and which is connected to a dedicated energy store.

A likewise preferred refinement of an embodiment of the invention may also provide for the device for detecting a connection operation to be a vibration sensor, which is fitted in, on or in the immediate vicinity of the low-voltage power circuit breaker, and which likewise has a dedicated energy store.

A further preferred refinement of an embodiment of the invention may also provide for the device for detecting a connection operation to be a piezoelectric sensor which interacts with the switching mechanism of the low-voltage power circuit breaker.

### BRIEF DESCRIPTION OF THE DRAWINGS

The invention will be explained in more detail below with reference to an exemplary embodiment. In the drawings:

FIG. 1 shows the outline circuit diagram of an electronic overcurrent release with detection of a connection operation via a momentary contact switch, and

FIG. 2 shows the outline circuit diagram of an electronic overcurrent release with detection of the connection operation by way of a piezoelectric sensor.

### DETAILED DESCRIPTION OF THE EXEMPLARY EMBODIMENTS

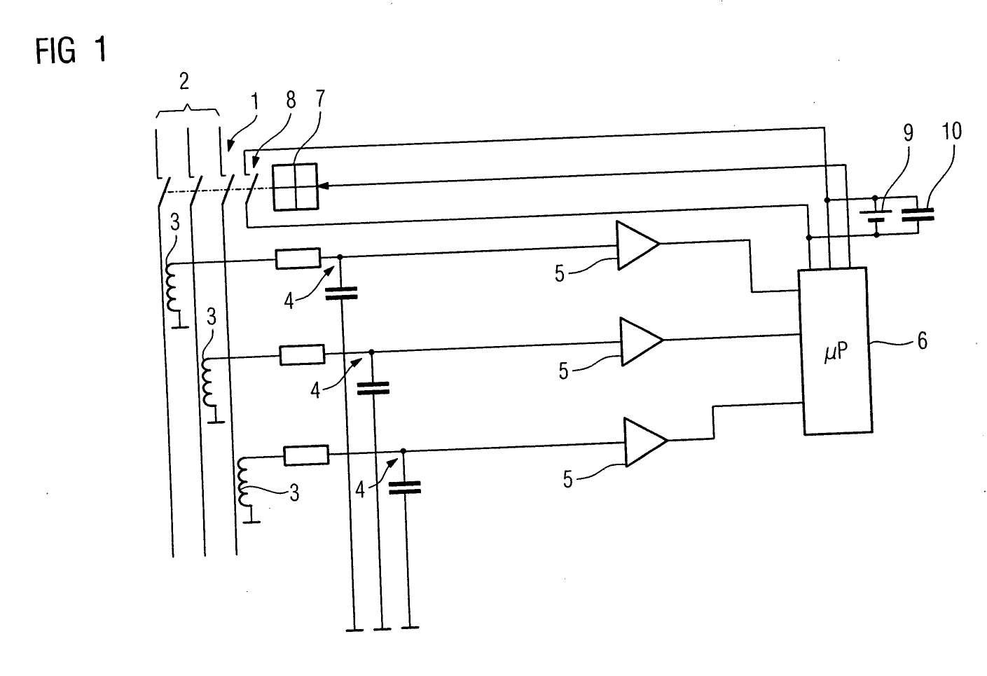

FIG. 1 shows an outline circuit diagram of an electronic overcurrent release for a low-voltage power circuit breaker 1 which is used to monitor a power supply system 2 for overcurrents. Uniform-field coils 3 are used as the current transformers for detecting the line currents. The outputs of the uniform-field coils 3 are connected to the inputs of measuring amplifiers 5 via a low-pass RC circuit 4, the outputs of said measuring amplifiers 5 being connected to a microprocessor 6.

The microprocessor 6 monitors the current signals for impermissibly high currents in the power supply system 2 and, in the case of an overload, establishes the disconnection delay. Any disconnection command is passed to a tripping magnet 7 of the low-voltage power circuit breaker 1, which initiates opening of the low-voltage power circuit breaker 1.

In order to detect a connection operation of the low-voltage power circuit breaker 1, its contacts are connected to a momentary contact switch 8. The alarm signal from the momentary contact switch 8 is fed to an input of the microprocessor 6. If the momentary contact switch 8 signals a closure operation of the low-voltage power circuit breaker 1, a minimum tripping time is set in the microprocessor 6 for a previously set period of time. For this purpose, the momentary contact switch 8 is connected to a dedicated energy store in the form of a battery 9, which is connected to a capacitor 10. Setting of the minimum tripping time is canceled again once the abovementioned period of time has expired.

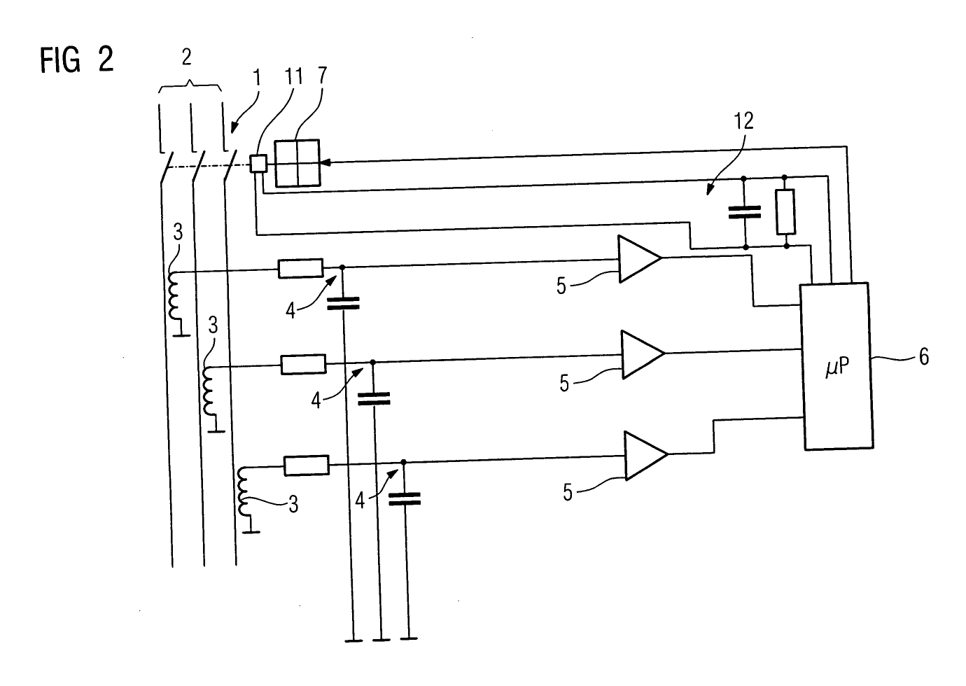

One disadvantage of the circuit shown in FIG. 1 is the additional complexity for the momentary contact switch 8, the supply line, plug contacts and the fact that it is not possible to develop existing switches by incorporating a release which has been extended in this way. This disadvantage is avoided if the electronic release is given directly a sensor for detecting the switching state of the power circuit breaker 1. The sensor may be, for example, a vibration sensor or, as is indicated in FIG. 2, a piezoelectric sensor 11, which has the advantage that it does not require a dedicated energy store 9. The piezoelectric sensor 11 signals, to the microprocessor 6, the connection of the low-voltage power circuit breaker 1 even before its main current contacts have closed.

The piezoelectric sensor 11 is mechanically connected to the switching mechanism of the low-voltage power circuit breaker 1 and, when the low-voltage power circuit breaker 1 is connected, emits a voltage pulse which is expediently buffer-stored in a capacitor 12.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A low-voltage power circuit breaker, comprising:
an electronic overcurrent release, which draws its operating energy from a power supply system monitored by the low-voltage power circuit breaker; and
an operating-state detection device for detecting a connection operation, whose output signal is fed to the overcurrent release, which sets a different disconnection time for the low-voltage power circuit breaker at the beginning of a connection operation for a predetermined period of time.

2. The low-voltage power circuit breaker as claimed in claim 1, wherein the device for detecting a connection operation is a momentary contact switch, mechanically connected to the main current contacts of the low-voltage power circuit breaker, and connected to a dedicated energy store.

3. The low-voltage power circuit breaker as claimed in claim 1, wherein the device for detecting a connection operation is a vibration sensor, fitted in, on or in the immediate vicinity of the low-voltage power circuit breaker, and including a dedicated energy store.

4. The low-voltage power circuit breaker as claimed in claim 1, wherein the device for detecting a connection operation is a piezoelectric sensor which interacts with the switching mechanism of the low-voltage power circuit breaker.

5. The low-voltage power circuit breaker as claimed in claim 4, further comprising a capacitor, which temporarily stores the pulse from the piezoelectric sensor.

6. A low-voltage power circuit breaker, comprising:
an electronic overcurrent release, which draws its operating energy from a power supply system monitored by the low-voltage power circuit breaker; and
means for detecting a connection operation, whose output signal is fed to the overcurrent release, and for setting a different disconnection time for the low-voltage power circuit breaker at the beginning of a connection operation for a predetermined period of time.

7. The low-voltage power circuit breaker as claimed in claim 6, wherein the means for detecting a connection operation includes a momentary contact switch, mechanically connected to the main current contacts of the low-voltage power circuit breaker, and connected to a dedicated energy store.

8. The low-voltage power circuit breaker as claimed in claim 6, wherein the means for detecting a connection operation includes a vibration sensor, fitted in, on or in the immediate vicinity of the low-voltage power circuit breaker, and including a dedicated energy store.

9. The low-voltage power circuit breaker as claimed in claim 6, wherein the means for detecting a connection operation includes a piezoelectric sensor which interacts with the switching mechanism of the low-voltage power circuit breaker.

10. The low-voltage power circuit breaker as claimed in claim 9, further comprising a capacitor, which temporarily stores the pulse from the piezoelectric sensor.
